(19) United States
(12) Patent Application Publication
(10) Pub. No.: US 2024/0144077 A1
(43) Pub. Date: May 2, 2024

(54) Systems and Methods for Integrating Text Analysis of Lithological Descriptions with Petrophysical Models

(71) Applicant: Saudi Arabian Oil Company, Dhahran (SA)

(72) Inventors: Abdullah A. Alakeely, Tarout (SA); Majed Fareed Kanfar, Dhahran (SA)

(21) Appl. No.: 17/977,947

(22) Filed: Oct. 31, 2022

(51) Int. Cl. G06N 20/00; G06F 40/40

(52) U.S. Cl. CPC G06N 20/00; G06F 40/40

(57) ABSTRACT

A computer-implemented method for integrating text analysis of lithological descriptions with petrophysical models is described herein. The method includes preprocessing textual descriptions associated with cuttings to generate training data and generating bag-of-words vectors using the training data. The method also includes training a deep learning model to output hydrocarbon potential using the bag-of-words vectors as input and executing the trained deep learning model on unseen textual descriptions.

### TECHNICAL FIELD

This disclosure relates generally to text analysis of lithological descriptions.

### BACKGROUND

Drilling processes typically generate rock drill cuttings via a drill bit positioned at the end of a drill string. The drill bit contacts a cutting face of a geological formation to create a wellbore. Contact with the cutting face creates rock drill cuttings. The rock drill cuttings are interpreted by textually describing the the cuttings. Interpretation of the rock drill cuttings provides information on the corresponding geological formation.

### SUMMARY

An embodiment described herein provides a computer-implemented method. The method includes preprocessing, with one or more hardware processors, textual descriptions associated with cuttings to generate training data, and generating, with the one or more hardware processors, bag-of-words vectors using the training data. The method also includes training, with the one or more hardware processors, a deep learning model to output hydrocarbon potential using the bag-of-words vectors as input, and executing, with the one or more hardware processors, the trained deep learning model on unseen textual descriptions.

An embodiment described herein provides an apparatus comprising a non-transitory, computer readable, storage medium that stores instructions that, when executed by at least one processor, cause the at least one processor to perform operations. The operations include preprocessing textual descriptions associated with cuttings to generate training data, and generating bag-of-words vectors using the training data. The operations also include training a deep learning model to output hydrocarbon potential using the bag-of-words vectors as input, and executing the trained deep learning model on unseen textual descriptions.

An embodiment described herein provides a system. The system includes one or more memory modules and one or more hardware processors communicably coupled to the one or more memory modules. The one or more hardware processors are configured to execute instructions stored on the one or more memory models to perform operations. The operations include preprocessing textual descriptions associated with cuttings to generate training data, and generating bag-of-words vectors using the training data. The operations also include training a deep learning model to output hydrocarbon potential using the bag-of-words vectors as input, and executing the trained deep learning model on unseen textual descriptions.

In some embodiments, the training data comprises textual descriptions of rock cuttings and an identification of hydrocarbon potential or no hydrocarbon potential for respective textual descriptions.

In some embodiments, the output of the trained deep learning model is used to inform hydrocarbon targets during drilling.

In some embodiments, the output of the trained deep learning model is integrated into petrophysical analysis of wells associated with the unseen textual descriptions.

In some embodiments, the output of the trained deep learning model is integrated with wireline logs associated with the wells corresponding to the unseen textual descriptions.

In some embodiments, the textual descriptions are generated by a visual inspection of the rock drill cuttings.

In some embodiments, the textual descriptions comprise lithological descriptions of rock at varying depths.

### BRIEF DESCRIPTION OF DRAWINGS

FIG. 1 shows data preparation.

FIG. 2 shows integrating text analysis of lithological descriptions with petrophysical models.

FIG. 3 is a process flow diagram of a process that enables integrating text analysis of lithological descriptions with petrophysical models.

FIG. 4 is a schematic illustration of an example controller (or control system) for integrating text analysis of lithological descriptions with petrophysical models according to the present disclosure.

### DETAILED DESCRIPTION

Rock drill cuttings, also referred to as drill cuttings or cuttings, are produced as rock is broken by a drill bit advancing through the rock or soil to create a wellbore. In examples, the cuttings are pieces of rock that are chipped away at a cutting face of a geological formation by the drill bit while the wellbore is drilled. Drilling fluid is pumped through a drill string coupled with the drill bit. The drilling fluid exits through jets in the drill bit and carries the cuttings through the hole and up to the surface. The cuttings are carried to the surface by drilling fluid circulating up from the drill bit. Equipment, such as a shaker, is used to separate the cuttings and fluid. A size of cuttings produced during drilling is based on, at least in part, the geologic material being drilled and the drill bit used. In examples, the cuttings are of any size. In some examples, the drilling fluid is collected at the surface in a containment system or pit.

The cuttings are interpreted to determine characteristics of the rock being drilled. Interpretation of the rock includes, for example, creating textual descriptions of the facies, mineralogy, or other categories of interest. In examples, the descriptions are referred to as lithological descriptions, and provide information on the lithology of the rock being drilled, the mineral composition, and hydrocarbon quality measurements. The cutting descriptions are made available by site geologists describing the penetrated rocks along the path of the well, and contain useful information that can be integrated to petrophysical analysis. In some cases, the cutting descriptions are not utilized during drilling operations due to the time sensitive horizon for drilling rigs (e.g., an integrated system that drills wells into the Earth's surface). For example, drilling operations are often beyond penetration of first rock and drilling at other rocks by the time the corresponding cutting descriptions of the first rock are available. In addition, hydrocarbon targets might be missed due to inability for integration between different sources of information. i.e. wireline logs and cutting descriptions. The present techniques include an efficient methodology that integrates a large amount of text into the petrophysical analysis. The present techniques scan the text for potential desired properties, and act as an advisor on summarizing the observed cuttings descriptions.

Embodiments described herein enable the integration of text analysis of lithological descriptions with petrophysical models. The present techniques integrate textual information with petrophysical models to reduce the uncertainty in identifying hydrocarbon targets and improve the efficiency of rig operation by eliminating unnecessary testing. In examples, natural language processing is used to process text that includes cuttings descriptions. The processed text is input to a deep learning algorithm that identifies hydrocarbon potential zones. The properties from the identified hydrocarbon potential zones of a first group of wells are propagated to newly drilled wells. The present techniques reduce the man-hours consumed to analyze text. In addition, the present techniques reduce the uncertainty in identifying hydrocarbon zones, while saving rig time from unnecessary testing.

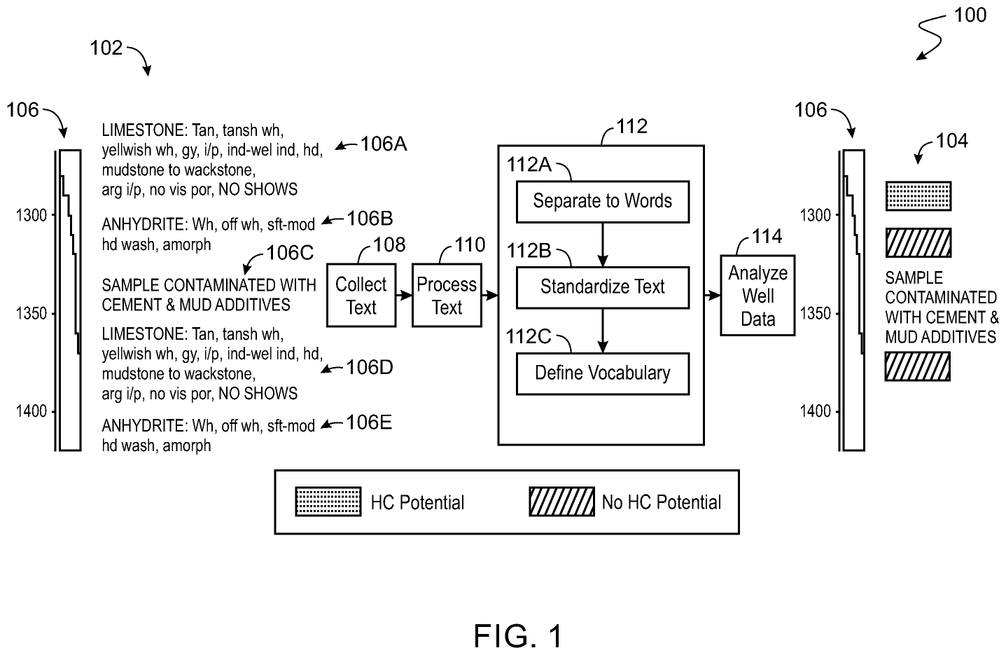

FIG. 1 shows data preparation. A preparation pipeline 100 is used to generate training data. The training data includes textual descriptions 102 of rock cuttings and an identification of hydrocarbon potential or no hydrocarbon potential 104 for respective textual descriptions. In the example of FIG. 1, textual descriptions 102 include texts that are created by site geologists describing the penetrated rocks along the path of the well at various depths. The textual descriptions include a written representation or account of the rock cuttings. In examples, the textual descriptions describe various properties associated with the rock cuttings, including but not limited to, rock type, lithological composition, color, hardness (induration), grain size, grain shape, sorting, luster, cementation or matrix, sedimentary structures, porosity, hydrocarbon show, stain, odor, fluorescence, cut, gas (total and petroleum vapor), or any combinations thereof. The textual descriptions 102 are associated with a depth 106. In the example of FIG. 1, at depth 106A, the rock cuttings are described as LIMESTONE: Tan, tansh wh, yellwish wh, gy i/p, ind-wel ind, hd, mudstone to wackestone, arg i/p, no vis por, NO SHOWS. At depth 106B, the rock cuttings are described as ANHYDRITE: Wh, off wh, sft-mod hd wash, amorph. At depth 106C, the rock cuttings are described as SAMPLE CONTAMINATED WITH CEMENT & MUD ADDITIVES. At depth 106D, the rock cuttings are described as LIMESTONE: Tan, tansh wh, yellwish wh, gy i/p, ind-wel ind, hd, mudstone to wackestone, arg i/p, no vis por, NO SHOWS. At depth 106E, the rock cuttings are described as ANHYDRITE: Wh, off wh, sft-mod hd wash, amorph.

At reference number 108, the textual descriptions 102 are extracted from a geological corpus. In examples, the text is collected in a data object (e.g., a data frame), where the text and associated descriptions are indexed according to depth.

At reference number 110, the collected text is processed. In some examples, the processing the collected text includes replacing known abbreviations with full words or correcting misspelled words. At reference number 112, the processed text is prepared for analysis.

At reference number 112A, the cutting descriptions (e.g., processed text) at each depth is separated into words (tokens). At reference number 112B, the tokens are standardized. For example, standardizing the words includes normalizing the words by converting letters to lowercase. Standardizing the words also includes removing non-alpha characters from the words. Non-alpha characters include, for example, commas, dots, hashes, etc. At reference number 112C, the vocabulary is defined. In examples, keywords are identified that are used to identify a positive or negative category. Examples of keywords are odor, hydrocarbon, stain, fluorescence, streaming, and the like. In some embodiments, the keywords are predetermined words of interest that are used to search for hydrocarbon in a cutting. The keywords can be changed based on opinion and experience, or according to operational parameters. In examples, keywords of interest are identified.

Rules are applied to classify the description at each depth as positive (contains keyword) or negative (does not contain keyword). Consider an example with the following set of keywords of interest: K={odor, hydrocarbon, stain, fluorescence, streaming}. In this example, for each depth, iterate over the textual descriptions in a loop and set a depth category, C, to:
C=1 if depth contains a word from K.
C=0 if depth does not contain a word from K.

For each depth with C=1, the depths form a set of depths associated with keywords for the well.

At reference number 114, the well data is analyzed. In examples, the words/tokens extracted from the cuttings descriptions are analyzed to obtain training data including hydrocarbon identifications 104 at varying depths 106.

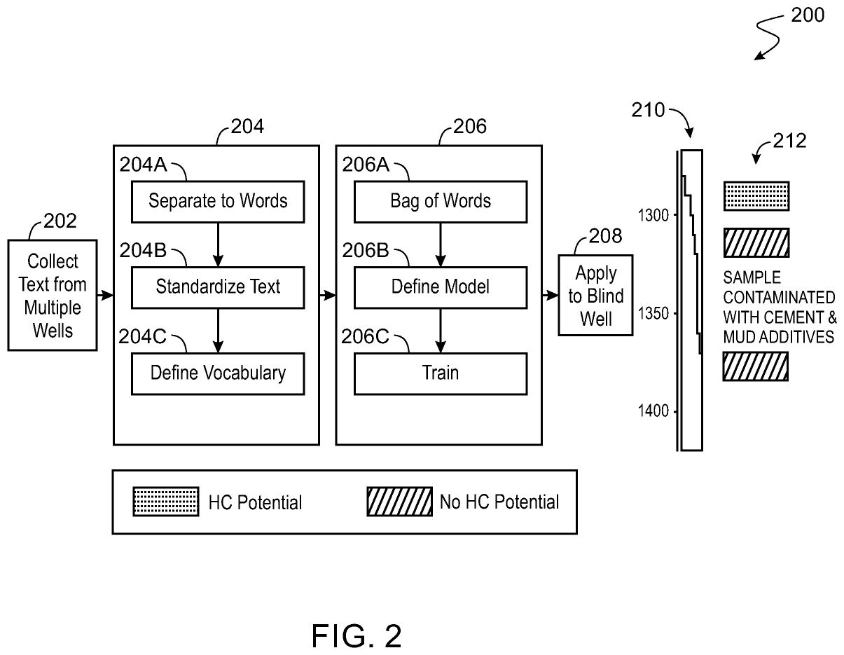

FIG. 2 shows integrating text analysis of lithological descriptions with petrophysical models. In examples, depth indexed textual descriptions are independently compared to wireline logs. The logs include lithological and fluid information, and the textual descriptions are used in tandem with the logs to confirm or negate observations from wireline logs. In examples, wireline logs are a continuous measurement of formation properties with electrically powered instruments to infer properties and make decisions about drilling and production operations.

In some embodiments, wireline measurements are made using a logging tool that is lowered into the open wellbore on wireline cable. Wireline measurements are taken (or logged) as the logging tool is lowered into the wellbore or as the logging tool is extracted from the wellbore. In examples, the wireline measurements correlate to a depth. Examples of measurements captured via wireline logs include resistivity, conductivity, sonic properties, active and passive nuclear measurements, dimensional measurements of the wellbore, formation fluid sampling, formation pressure measurement, wireline-conveyed sidewall coring tools, and the like. The present techniques are not limited to the wireline measurements as described herein, and can be applied to any wireline measurements.

At reference number 202, textual descriptions from multiple wells are collected. The textual descriptions include texts that are created by site geologists describing the penetrated rocks along the path of the well at various depths. At reference number 204, the text is prepared as described by the preparation pipeline 100 of FIG. 1. For example, at reference number 204A the text is separated into words/tokens. At reference number 204B, the text is standardized. At reference number 204C, a vocabulary is defined.

At reference number 206, a bag-of-words model is prepared. In examples, the bag-of-words model is prepared using the training data (e.g., hydrocarbon identifications 104 at varying depths 106) generated by the data preparation pipeline 100 of FIG. 1. The bag-of-words model is a representation used in natural language processing and information retrieval (IR). In this model, a text (such as a sentence or a document) is represented as the bag (multiset) of its words, disregarding grammar and word order but keeping multiplicity. In examples, the bag-of-words describes the occurrence of words within a document according to a vocabulary of known words and a measure of the presence of known words. Information about the order or structure of words in the document is discarded.

At reference number 206A, a bag-of-words vector is obtained. The separate words from the collection of wells is collected in a set of unique words that are used then to create a bag-of-words vectors of dimension equal to that of number of unique words in the text corpus. The bag-of-words vector is a numerical representation of text descriptions at each depth. A numerical value is assigned to these words that corresponds to its relative frequency in the sentence. For example, if the word shows up two times at a depth, and there are a total of ten words at that depth, then:

$${T}_{w f} = \frac{2}{10} = 0.2$$

where T is a relative frequency of the word, and wf signifies the word frequency. Assume that the relationship between the classification (positive or negative) and the text description is described by a function. This function is composed of multiple layers, and parametrized by weights that are found through the learning process. In general, the function is written as:

f(x)=Y,
Where, xϵR^{d×n}, is an input sequence of n tokens frequencies sampled form d depth points. Assume that the values of token frequencies are ordered within a sentence according to the word/token position within the sentence. The output of the bag-of-words model, yϵR^{d×2}, is a probability curve with d sample points.

At reference number 206B, the model is defined. In examples, the following transformation layers are used:

a^{[1]}=x^{T}W^{[1]}+b^{[1]}, (1)

a^{[2]}=a^{[1]T}W^{[2]}+b^{[2]}

y=a^{[3]}=softmax(a^{[2]T}W^{[3]}+b^{[3]})
where T is the transpose of the matrix or vector, W is the weight of the layer (matrix), and b is a bias term (a numerical value). At reference number 206C, the model is trained. A deep learning model is then trained to take as an input bag-of-words vector, X, and output as a classification the probability of positive for hydrocarbon potential or negative for hydrocarbon potential according to the above transformations.

At reference number 208, the trained model is applied to blind wells. For example, textual descriptions from new or unobserved wells are provided as input to the trained model. The trained model outputs hydrocarbon identifications 212 at various depths 210.

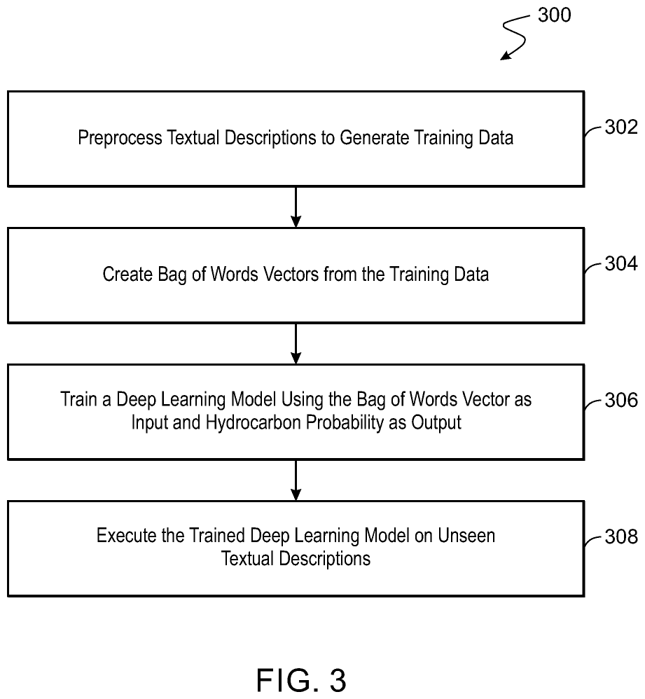

FIG. 3 is a process flow diagram of a process 300 that enables integrating text analysis of lithological descriptions with petrophysical models. The present techniques collect text descriptions of rock cuttings and use the descriptions to determine a probability of positive for hydrocarbon presence or negative for hydrocarbon presence at varying depths. In examples, positive refers to the existence of hydrocarbons and negative refers to a lack of hydrocarbons.

At block 302, textual descriptions associated with cuttings are preprocessed to generate training data. The textual descriptions include text that describes cuttings at various depths.

At block 304, the training data is used to create a bag-of-words vector. The bag-of-words vector is generated based on a relative frequency of keywords in the text corpus.

At block 306, a deep learning model is trained to take as the input bag-of-words vector, X, and output a classification that indicates the probability of positive for hydrocarbon potential or negative for hydrocarbon potential.

At block 308, the trained deep learning model is executed on unseen textual descriptions. Unseen textual descriptions are from other wells, where the description of the other wells is not used to generate training data. In examples, the trained deep learning model outputs a classification associated with depths of the textual descriptions. The classification may be, for example, in the form of a probability curve. In examples, the classification identifies a probability of a depth as being positive for hydrocarbon potential (hydrocarbons exist) or negative for hydrocarbon potential (hydrocarbons do not exist). In some embodiments, the classifications inform drill operations at the unseen well. For example, drilling operations can target depths of the unseen wells that are positive for hydrocarbon potential. Additionally, drilling operations can avoid targeting from depths of the unseen wells that are negative for hydrocarbon potential.

By not using manual interpretation, costs and time associated with cuttings interpretations are reduced. For example, when a new built-for-purpose model is created for a specific region, then a set of highly qualified individuals need to assembled to work on a time consuming and repetitive task. The response time and cost of such methodology offsets any gain to be achieved by modifying the current industry practice. The present techniques enable rock drill cuttings to be used to interpret the mineralogy of the samples, and also continuous or discrete quantities related to the shape, color, texture and size of the cuttings produced.

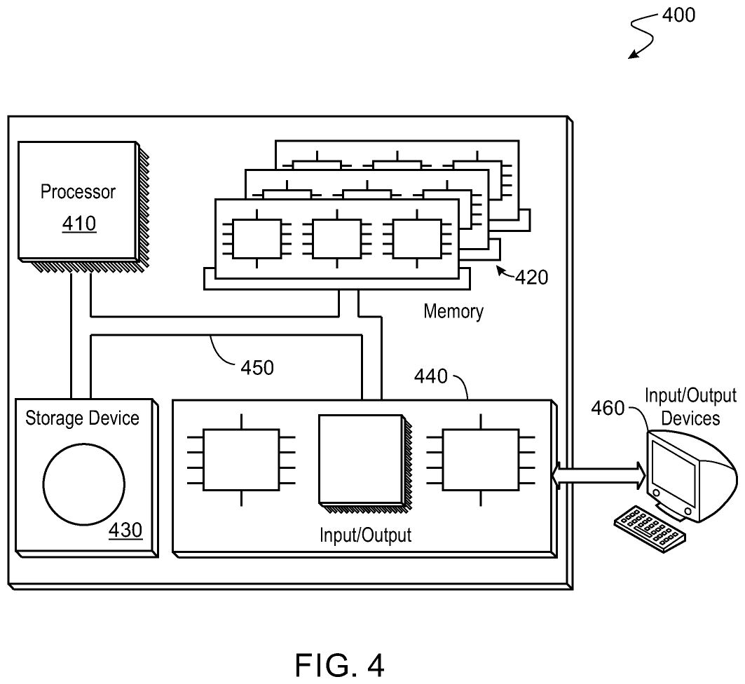

FIG. 4 is a schematic illustration of an example controller 400 (or control system) for integrating text analysis of lithological descriptions with petrophysical models according to the present disclosure. For example, the controller 400 may be operable according to the models of FIG. 1 or FIG. 2, or the process 300 of FIG. 3. The controller 400 is intended to include various forms of digital computers, such as printed circuit boards (PCB), processors, digital circuitry, or otherwise parts of a system for automated dew point pressure prediction. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 400 includes a processor 410, a memory 420, a storage device 430, and an input/output interface 440 communicatively coupled with input/output devices 460 (for example, displays, keyboards, measurement devices, sensors, valves, pumps). Each of the components 410, 420, 430, and 440 are interconnected using a system bus 450. The processor 410 is capable of processing instructions for execution within the controller 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface via the input/output interface 440 at an input/output device 460.

The memory 420 stores information within the controller 400. In one implementation, the memory 420 is a computer-readable medium. In one implementation, the memory 420 is a volatile memory unit. In another implementation, the memory 420 is a nonvolatile memory unit.

The storage device 430 is capable of providing mass storage for the controller 400. In one implementation, the storage device 430 is a computer-readable medium. In various different implementations, the storage device 430 may be a floppy disk device, a hard disk device, an optical disk device, or a tape device.

The input/output interface 440 provides input/output operations for the controller 400. In one implementation, the input/output devices 460 includes a keyboard and/or pointing device. In another implementation, the input/output devices 460 includes a display unit for displaying graphical user interfaces.

There can be any number of controllers 400 associated with, or external to, a computer system containing controller 400, with each controller 400 communicating over a network. Further, the terms “client,” “user,” and other appropriate terminology can be used interchangeably, as appropriate, without departing from the scope of the present disclosure. Moreover, the present disclosure contemplates that many users can use one controller 400 and one user can use multiple controllers 400.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method, comprising:
preprocessing, with one or more hardware processors, textual descriptions associated with cuttings to generate training data;
generating, with the one or more hardware processors, bag-of-words vectors using the training data;
training, with the one or more hardware processors, a deep learning model to output hydrocarbon potential using the bag-of-words vectors as input; and
executing, with the one or more hardware processors, the trained deep learning model on unseen textual descriptions.

2. The computer implemented method of claim 1, wherein the training data comprises textual descriptions of rock cuttings and an identification of hydrocarbon potential or no hydrocarbon potential for respective textual descriptions.

3. The computer implemented method of claim 1, wherein output of the trained deep learning model is used to inform hydrocarbon targets during drilling.

4. The computer implemented method of claim 1, wherein the output of the trained deep learning model is integrated into petrophysical analysis of wells associated with the unseen textual descriptions.

5. The computer implemented method of claim 1, wherein the output of the trained deep learning model is integrated with wireline logs associated with wells corresponding to the unseen textual descriptions.

6. The computer implemented method of claim 1, wherein the textual descriptions are generated by a visual inspection of rock drill cuttings.

7. The computer implemented method of claim 1, wherein the textual descriptions comprise lithological descriptions of rock at varying depths.

8. An apparatus comprising a non-transitory, computer readable, storage medium that stores instructions that, when executed by at least one processor, cause the at least one processor to perform operations comprising:
preprocessing textual descriptions associated with cuttings to generate training data;
generating bag-of-words vectors using the training data;
training a deep learning model to output hydrocarbon potential using the bag-of-words vectors as input; and
executing the trained deep learning model on unseen textual descriptions.

9. The apparatus of claim 8, wherein the training data comprises textual descriptions of rock cuttings and an identification of hydrocarbon potential or no hydrocarbon potential for respective textual descriptions.

10. The apparatus of claim 8, wherein output of the trained deep learning model is used to inform hydrocarbon targets during drilling.

11. The apparatus of claim 8, wherein the output of the trained deep learning model is integrated into petrophysical analysis of wells associated with the unseen textual descriptions.

12. The apparatus of claim 8, wherein the output of the trained deep learning model is integrated with wireline logs associated with wells corresponding to the unseen textual descriptions.

13. The apparatus of claim 8, wherein the textual descriptions are generated by a visual inspection of rock drill cuttings.

14. The apparatus of claim 8, wherein the textual descriptions comprise lithological descriptions of rock at varying depths.

15. A system, comprising:
one or more memory modules;
one or more hardware processors communicably coupled to the one or more memory modules, the one or more hardware processors configured to execute instructions stored on the one or more memory models to perform operations comprising:
preprocessing textual descriptions associated with cuttings to generate training data;
generating bag-of-words vectors using the training data;
training a deep learning model to output hydrocarbon potential using the bag-of-words vectors as input; and
executing the trained deep learning model on unseen textual descriptions.

16. The system of claim 15, wherein the training data comprises textual descriptions of rock cuttings and an identification of hydrocarbon potential or no hydrocarbon potential for respective textual descriptions.

17. The system of claim 15, wherein output of the trained deep learning model is used to inform hydrocarbon targets during drilling.

18. The system of claim 15, wherein the output of the trained deep learning model is integrated into petrophysical analysis of wells associated with the unseen textual descriptions.

19. The system of claim 15, wherein the output of the trained deep learning model is integrated with wireline logs associated with wells corresponding to the unseen textual descriptions.

20. The system of claim 15, wherein the textual descriptions are generated by a visual inspection of rock drill cuttings.
